(19) United States
(12) Patent Application Publication
(10) Pub. No.: US 2008/0116324 A1
(43) Pub. Date: May 22, 2008

(54) Shaping Guide for Vehicular Mounted Tubing

(75) Inventor: Danny D. Holder, Kernersville, NC (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: Volvo Trucks North America, Greensboro, NC (US)

(21) Appl. No.: 11/883,861

(22) PCT Filed: Feb. 8, 2005
(86) PCT No.: PCT/US05/03930

§ 371 Date: Aug. 7, 2007

(51) Int. Cl. F16L 3/08

(52) U.S. Cl. 248/65

(57) ABSTRACT

A shaping guide for tubing carried on a vehicle and in which the tubing has elastic deformation characteristics. The guide includes an elongate guide body configured to be supported exclusively on an elastically deformable tubing section that is to be bent from a natural shape into a bent shape while in use upon the vehicle. The guide body defines an interior trap space in which an installed tubing section is retained once positioned therein. The guide can be utilized for maintaining a tubing's shape that is carried on a vehicle that undergoes heat processing at temperatures sufficiently high to permit plastic deformation (sag or collapse) of the tubing's shape under the tubing's own weight.

### TECHNICAL FIELD

The present invention relates to vehicle parts and components; and more specifically, to guides or directors for tubing utilized on a vehicle for conveying fluids and/or communicating pressure.

### BACKGROUND ART

Fluid conveying tubing is used on vehicles for various applications including gases, such as air, hydraulic oil, water, fuel and other liquids, and even mixed-phase fluids having both gaseous and liquid constituencies.

Those persons skilled in the relevant vehicular arts will readily recognize the problems that can result from disorganized tubing systems. FIG. 1 schematically demonstrates the unorganized, tubing tangles 42 that can occur in a vehicle's engine compartment 22 when tubes associated with the motor are secured only at both distal ends, but left uncontrolled therebetween.

A related situation often encountered on commercial vehicles is found at the back of the cab of a truck where sets of tubes have traditionally been found that are unorganized and uncontrolled. It may be appreciated that each individual tube is adapted for interconnection and securement to the vehicle at distal ends thereof, but are otherwise left free to swing about, potentially becoming entangled with one another, and at a minimum, slapping into adjacent portions of the vehicle with a possible result being damage to the vehicle's finish. A more serious operational concern, however, is the likelihood that damage will instead be caused to the tubing itself over prolonged periods of time, potentially resulting in related system failures.

A similar situation can also be appreciated in conventional configurations found at the back of truck cabs wherein undirected tubing can lie against or on vehicle components. Among other detrimental effects, such contact with other vehicle components (obstacles) can result in wear to the tubing and/or entanglement therewith, both of which are undesirable from an operational point of view.

In the vehicular arts, pneumatic systems are commonly known and generally refer to the use of pressured air to perform certain functions. In such systems, it should be appreciated that pressured air can flow through the conveyance tubing, or air may be held substantially static within the tubing, with induced pressure changes communicated thereacross. One well-known example is the use of air-actuated, pneumatic brakes on commercial vehicles. On a commercial vehicle, there is typically a common source of pressured air that is distributed via conduits to different locations upon the vehicle. Frequently, pneumatic air distribution is effected through plastic tubing. Normally such air pressure distribution tubing has a certain degree of flexibility, especially over relatively long lengths, but when shorter lengths of conduit are considered, the tubing generally possesses a stiffness quality that resists lengthwise deformation or bending. These characteristics precipitate the kinking or crimping propensities that are common to such tubing when bent to too great an extent. Such kinking and crimping detrimentally compromises and/or precludes fluid throughput in the effected tubing, and therefore is desirably avoided.

FIG. 5 provides an illustration of a commonly recognized air pressure distribution valve that is configurable for controlling and distributing pressured air from a common source to eight different channels (tubes) for distribution. In this traditional design, the main valve body is provided with receiving annuluses into which an angle adapter or interconnect is engaged for sealing engagement therewith. The tubing section is then oppositely attached to the adapter utilizing an integrated quick-connector. In this manner, even though long axes of the receiving annuluses are oriented perpendicularly to the long axis of the distribution valve, the angle adapters make it possible for tubing extending therefrom to be variably configured with respect to the valve housing, and to even be configured in substantial alignment with the long axis of the valve housing. From a design perspective, this has traditionally been a beneficial arrangement in that other components are often located in close proximity to the distribution valve and are viewed as obstacles to tubing projecting radially from the valve housing. Therefore, the right-angle adapters facilitate a designer's need to be able to variably configure the direction at which such tubing projects from the valve housing.

Drawbacks related with such right-angle adapters, however, include a relatively high cost for parts and labor for installation, as well as a propensity for leakage. For these reasons a quick-connect has been developed that allows the pneumatic tubes to be stab-inserted directly into the annuluses of the distribution valve. A negative consequence of this assembly, however, is that the pneumatic tubes project from the distribution valve in the direction of the annuluses, thereby taking up valuable space with their resulting spider leg-type configuration. Such arrangements make the tubes likely to encounter proximate components as obstacles as discussed above. Therefore, it has been recognized as desirable to provide adaptations to these radially projecting tubes that affect a quick bend from the radial direction thereby directing the tube in a desired direction more quickly.

In another aspect, tube conveyances, particularly those that are oriented lengthwise with respect to the vehicle, are often located within the interior space of frame members. Frequently such frame-borne tubing is installed prior to certain heat treatments being applied to the frame such as during painting and for anti-corrosion. In that such tubing is typically constructed from plastic, these heat treatments can significantly soften the tubing and permit it to sag between support points, or even collapse upon itself under its own weight. In either case, the fluid throughput of a so-effected conduit can be sufficiently compromised that it requires post heat treatment replacement, which is an expensive, time-consuming and undesirable consequence.

The present invention has been developed to meet the above described needs, as well as provide additional benefits which will become evident from the disclosure provided herein.

### DISCLOSURE OF INVENTION

The present invention, though elegantly simple in nature, provides a host of benefits to owners and operators of all types of vehicles, and particularly those owners and operators of commercial vehicle fleets. As discussed hereinabove, there is a clearly recognizable need for tools that enable the organization and designer-directed orientation of tubes carried upon vehicles. The present invention provides just such a shaping guide for vehicle tubing that can be advantageously applied directly upon the tube itself, without support or interference with any surrounding structure. This is highly beneficial in that it makes the customization and direction of tubing courses or paths substantially independent of environmental structures, many of which have been previously seen as obstacles, and with which contact is desirably avoided.

Therefore, primary benefits associated with the present invention's inclusion are that it enables direction of individual tubes, for instance, around a particular obstacle, and in the aggregate, to organize and control multi-tubing bundles or systems. In the first instance, the avoidance of obstacles protects the tubing and the obstacle structure from potentially wearing contact therebetween. In an associated aspect, the shaping guide, if positioned between the tube and obstacle, acts as a buffer between the two elements should contact occur; and moreover, the guide acts as a protector to the supporting tube by preventing wear-degradation that can occur from undesirable contact with neighboring structures (see FIG. 4). From an organizational perspective, utilization of a system of shaping guides advantageously eliminates tubing tangles and enables the institution of tubing-order where tubing-disorder previously existed (see FIG. 2).

In this regard, at least one embodiment of the present invention may be characterized as a shaping guide for tubing carried on a vehicle and that has elastic deformation characteristics. The guide includes an elongate guide body configured to be supported exclusively on an elastically deformable tubing section that is to be bent from a natural shape into a bent shape while in use upon the vehicle. In this regard, the natural shape of the tubing is that which it assumes when no outside forces are imposed thereupon. It should be appreciated that this natural shape may be straight or curved, but is typically slightly curved due to the fact that tubing is normally stored in a coiled configuration prior to installation. The guide body defines an interior trap space in which an installed tubing section is retained once positioned therein.

A further beneficial aspect of the invention stems from its substantially continuous support of the tube along the length of the guide. This continuous support enables a more acute angle to be imposed on the tube than its prescribed minimum radius. Tubing manufacturer's specifications typically prescribe a minimum radius around which the tubing should be allowed to bend to avoid the possibility of kinking the tube. Through the full support provided by the instant shaping guide, however, it has been discovered that this prescribed minimum radius can be reduced by as much as ten percent, or more. As an example, where a minimum radius of ten inches has been prescribed, utilization of the guide permits at least a ten percent reduction, which in the present illustrative case would be to a nine inch minimum radius. Where packaging is of paramount concern such as in the tight space of a vehicle's engine compartment, the ability to effect such a tubing bend-radius reduction is highly advantageous. Therefore, in one aspect, the shaping guide constitutes a means for bending an installed tubing section on a radius lesser than its prescribed minimum bend radius.

In a related but different application of the present invention, the shaping guide can be configured to have a substantially straight body, or at least one of lesser curvature than described above with respect to imposing tight bending radii in concerned tubing. With regard to the heat treating processes earlier discussed and to which tubing located in vehicle frame members may be required to undergo, shaping guides according to the present invention may be utilized to maintain the shape of the tubing during such heat treatment thereby preventing deformation of the tubing structure itself. It is contemplated that in this type of application, the guide may be exclusively supported upon the tube, or may be partially supported on other structure of the vehicle thereby actually acting as a support to the tube, as opposed to merely a guide for its shape. In any event, maintenance of the desired shape and configuration of the tube through such heat treating processes is highly desirable and eliminates the high cost and time delay of replacing heat-damaged tubing which sometimes has previously occurred.

In this regard, at least one embodiment of the present invention may be characterized as a shape maintaining guide for tubing that is carried on a vehicle that undergoes heat processing at temperatures sufficiently high to permit plastic deformation (sag or collapse) of the tubing's shape under the tubing's own weight. For example, such heat treatment includes painting and anti-corrosion processes to which tube-carrying frame members of the vehicle may be subjected. The guide includes an elongate guide body configured to be at least partially supported on an elastically deformable tubing section that is to be maintained in a prescribed (required in the design criteria or specification) configuration while undergoing heat processing at temperatures sufficiently high to permit plastic deformation of the tubing's shape under the tubing's own weight. The guide body defines an interior receiving or trap space in which an installed tubing section is received, and optionally retained once positioned therein.

In a particularly advantageous embodiment, and that which is depicted in the accompanying drawings, the shaping guide is of a snap-on design, preferably constructed from semi-rigid plastic. The utilization of such plastic for the construction of the guide body is particularly desirable because the general shape of the guide is maintained by the semi-rigid qualities of the plastic for establishing the desired shape and course of the associated tubing. The plastic used in the guide's construction, however, is chosen to also have a minor degree of flexibility that accommodates its snap-on aspect which requires temporary expansion of a slotted opening into the guide for the tubing to be installed into the interior trap space of the guide.

Another beneficial aspect of utilizing plastic in the construction of the guide body is its light weight nature. As discussed hereinabove, the shaping guide of the present invention is designed to be exclusively supported upon the tubing it directs. Therefore it is highly desirable that the presence of the guide, and particularly its added weight, not negatively impact the tube upon which it is supported. For instance, utilizers of the guide will not want its inclusion to impose unnecessary “pulling” forces on secured ends of the concerned tubing. Still further, unnecessarily weighty guides could cause sagging along the supporting tube's length, or even induce undesired movement amplitude that would not occur in the tube alone. For these reasons, plastic is not merely a design choice, but instead provides a host of beneficial aspects that are considered desirable where the present invention is concerned.

These beneficial features of the several disclosed embodiments of the present invention will be appreciated by those persons skilled in the relevant arts, as will other benefits when the whole of the disclosure is considered.

### BRIEF DESCRIPTION OF THE DRAWINGS

Exemplary embodiments and environmental use aspects of the present invention are depicted in the accompanying drawings wherein:

FIG. 1 is a perspective view of a disorganized tubing arrangement in a vehicle's engine compartment;

FIG. 2 is a perspective view of an organized tubing arrangement according to the present invention, and in comparison to that of FIG. 1;

FIG. 3 is a perspective view showing both guided and unguided tubing sets at the back side of a commercial vehicle, as well as a cutaway portion thereof that depicts tubing located in a vehicle frame member that is subjected to heat treatment during manufacture;

FIG. 4 is a perspective view of an obstacle-engaging tubing arrangement (left-hand side) and an obstacle-diverted tubing arrangement (right-hand side) according to the present invention;

FIG. 5 is an exploded perspective view of a fluid pressure distribution valve or juncture, including right-angle tubing interconnectors;

FIG. 6 is a perspective view of tubing being directed immediately upon extension from the valve assembly utilizing shaping guides according to the present invention;

FIG. 7A is a top-side perspective view of a shaping guide configured according to one embodiment of the present invention posed for engagement upon a tubing section;

FIG. 7B is a perspective view corresponding to FIG. 7A, but in which the shaping guide has been installed upon the tubing section;

FIG. 8A is a bottom-side perspective view of the arrangement of FIG. 7A;

FIG. 8B is a bottom-side perspective view of the arrangement of FIG. 7B;

FIGS. 9A and 9B correspond to the configurations of FIGS. 7 and 8, but depict different colorations which can be exemplarily utilized for guide size designation;

FIGS. 10A and 11A depict bottom plan views of ninety degree shaping guides;

FIGS. 10B and 11B depict bottom plan views of one hundred and eighty degree shaping guides;

FIGS. 12A and 13A depict top plan views of ninety degree shaping guides;

FIGS. 12B and 13B depict top plan views of one hundred and eighty degree shaping guides;

FIG. 14 is a cross-sectional view taken perpendicularly to the longitudinal axis of the shaping guide at a securing portion thereof; and

FIG. 15 is a cross-sectional view depicting slight modification to the embodiment of FIG. 14.

### BEST MODE FOR CARRYING OUT THE INVENTION

In the accompanying drawings, tubing systems on various vehicles are depicted that can be improved through the utilization of the presently disclosed tubing shaping guide and/or support. Areas on certain vehicles that benefit from shaping guide installation are illustrated as examples. Still further, details of exemplary constructions and installations of the shaping guides are also shown. It should be appreciated that the description contained herein provides an example of implementations of the disclosed inventions, but the legal bounds of the afforded patent protection are exclusively defined by the words of the associated claims.

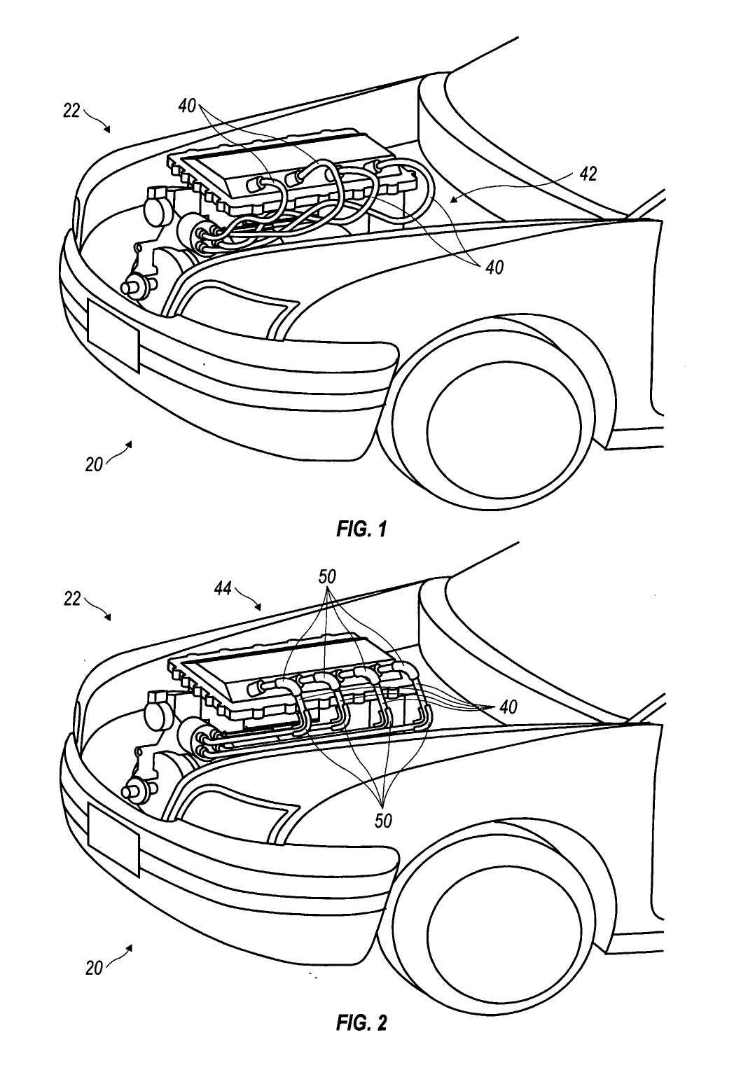

Referring to FIG. 1, an unadapted engine compartment 22 of a passenger vehicle 20 is depicted in which a set of elastically deformable tubing sections 40 are shown as a group of uncontrolled tubes 42 which undesirably tangle. In contrast, FIG. 2 depicts a similar, but organized set of tubes 44 in the engine compartment 22, thanks to the utilization of multiple shaping guides 50, each of which is configured according to the teachings of the present invention.

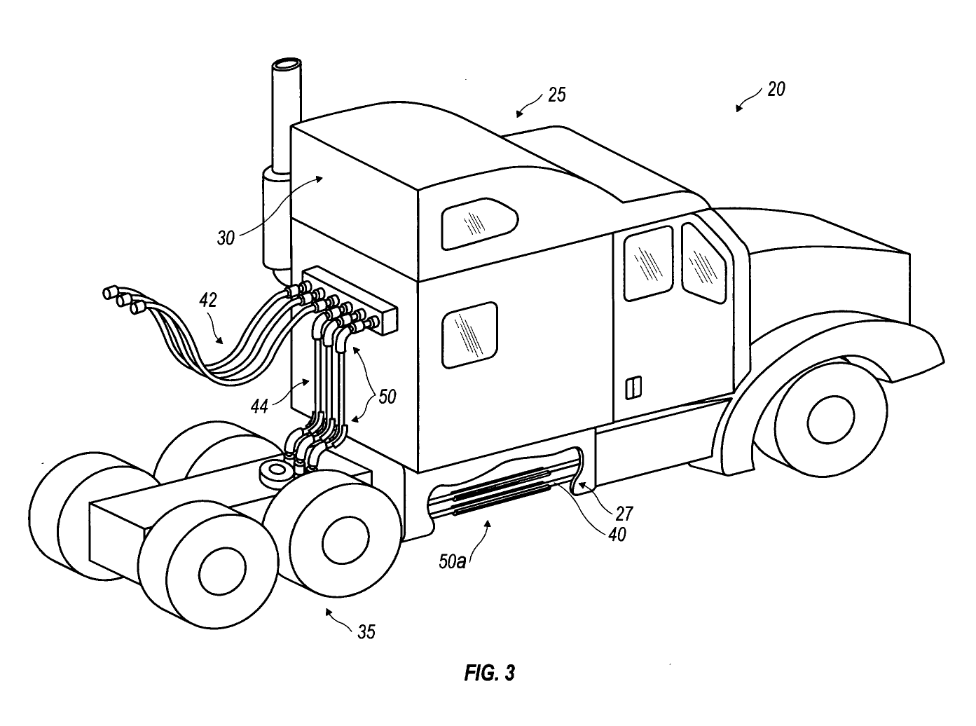

FIG. 3 shows exemplary uses of tubing shaping guides 50 on a commercial vehicle depicted as a highway truck tractor 20. At the left-hand side of the cab-back, a group of uncontrolled tubing sections 42 are shown that have traditionally draped in an uncontrolled manner from the back side 30 of the truck cab 25 toward a hitched trailer. In contrast, a similar group of tubes 44 are shown at the right-hand side thereof, and which include curved shaping guides 50 installed thereupon. In the example provided at the back side 30 of the cab 25, shaping guides 50 are employed to position the incorporating tubing lengths adjacent to the cab's body where they are less likely to cause or encounter interference and snags.

In an alternative configuration of the invention that is also depicted in FIG. 3, shape maintaining guides 50a are provided that support tubing that can be exemplarily located in a space 27 defined within a lower frame member of the truck 20 during heat treatments imposed in the course of the truck's manufacture. The shape maintaining guides 50a can be similarly constructed to the curved shaping guides 50 that are depicted in greater detail herein, but their elongate shape is more typically straight, or at least less sharply, and more smoothly curved. In this configuration, the shape maintaining guide 50a is intended to support and maintain the shape of the tubing when exposed to heat treatment during manufacture of the vehicle, as opposed to shaping and enforcing a bend in the tubing's length at ambient temperatures as does the curved shaping guide 50. It should be appreciated, however, that in certain circumstances, tubing that is naturally curved, for instance tubing that has been coiled for a period of time, may actually be straightened by the installation of the shape maintaining guide 50a, and it is this second, straightened configuration that the guide maintains when the tubing softens during applied heat treatment processes. Still further, because the guide supports at least half of the tubing in a substantially continuous manner during such heat treatment processes, greater resistance to self-collapse is provided to the supported tubing length 40.

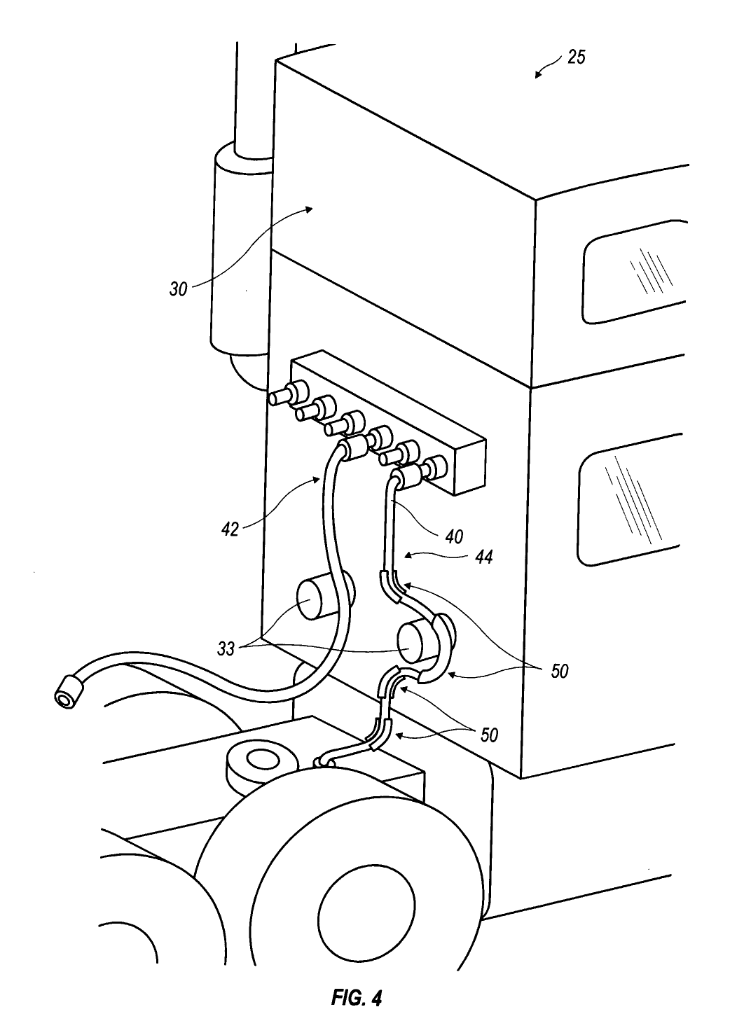

FIG. 4 depicts an alternative use of a combination of ninety degree and one hundred and eighty degree shaping guides 50 on tubing 40 for negotiating a structural obstacle 33. On a left-hand side of the back side 30 of the cab 25, an unadapted tubing length 42 is shown undesirably draped upon the obstacle 33. In contrast, a similar, but guided tubing configuration 44 is depicted at the right-hand side of the cab 30. Here, the tubing 44 is directed around the obstacle 33, but should the tubing assembly come in contact with the obstacle, the shaping guide 50 acts as a protective buffer therebetween.

FIG. 5 depicts an exploded view of an existing fluid distribution valve 46 having right-angle interconnectors 47 for connecting tubing to the valve housing as described in greater detail hereinabove. FIG. 6, however, illustrates a relatively new configuration 48 in which quick-connect adapters are pre-installed in the tubing-receiving annuluses of the valve housing. Utilizing these quick-connect devices, a tubing end is simply inserted into the annulus opening where it is releasably secured until intentionally disengaged. As previously discussed, the now radially configured projection of the extending tubes 40 must be redirected immediately adjacent to valve housing 48. For this purpose shaping guides 50 effecting relatively abrupt ninety degree turns are exemplarily shown in FIG. 6 installed thereupon, as examples.

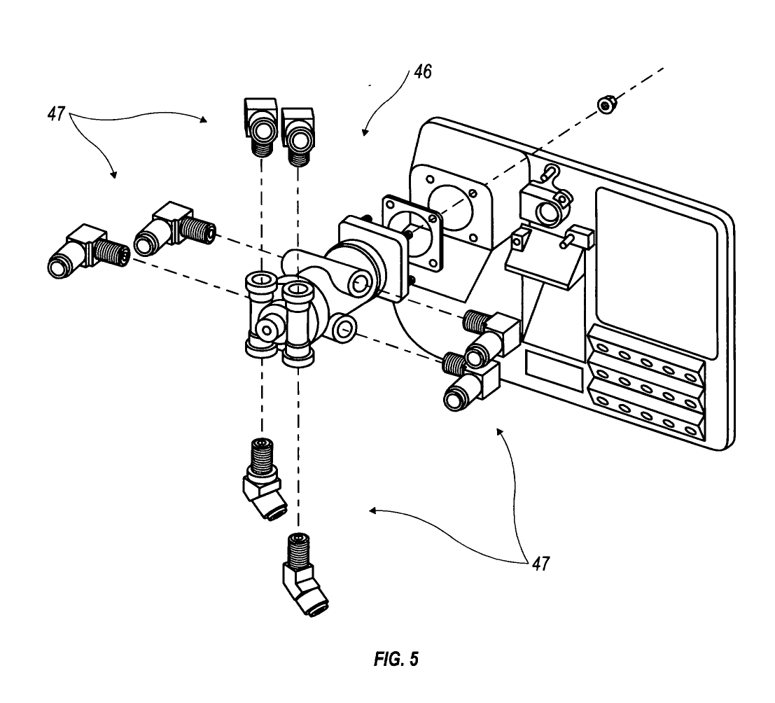

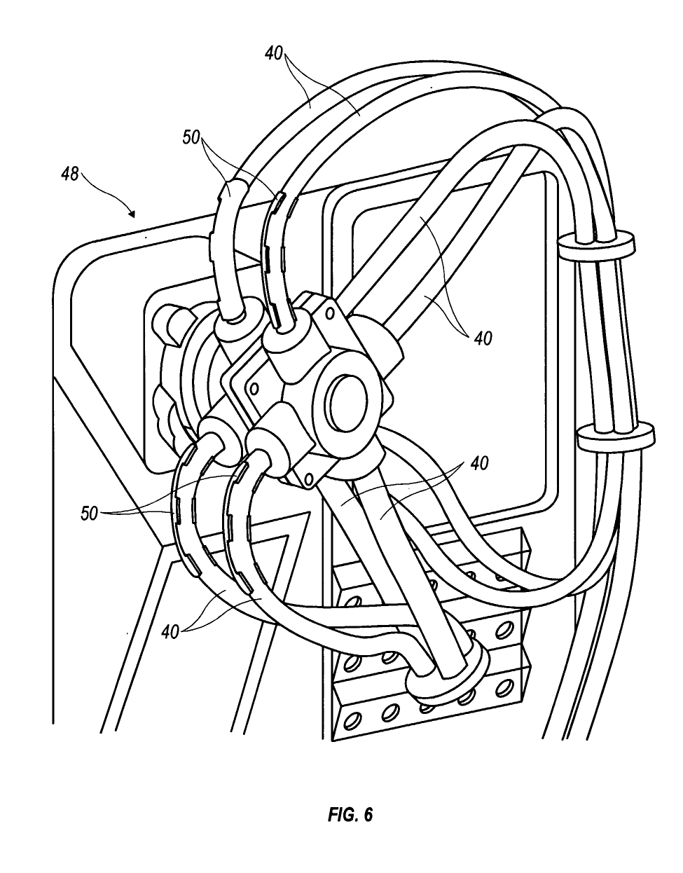

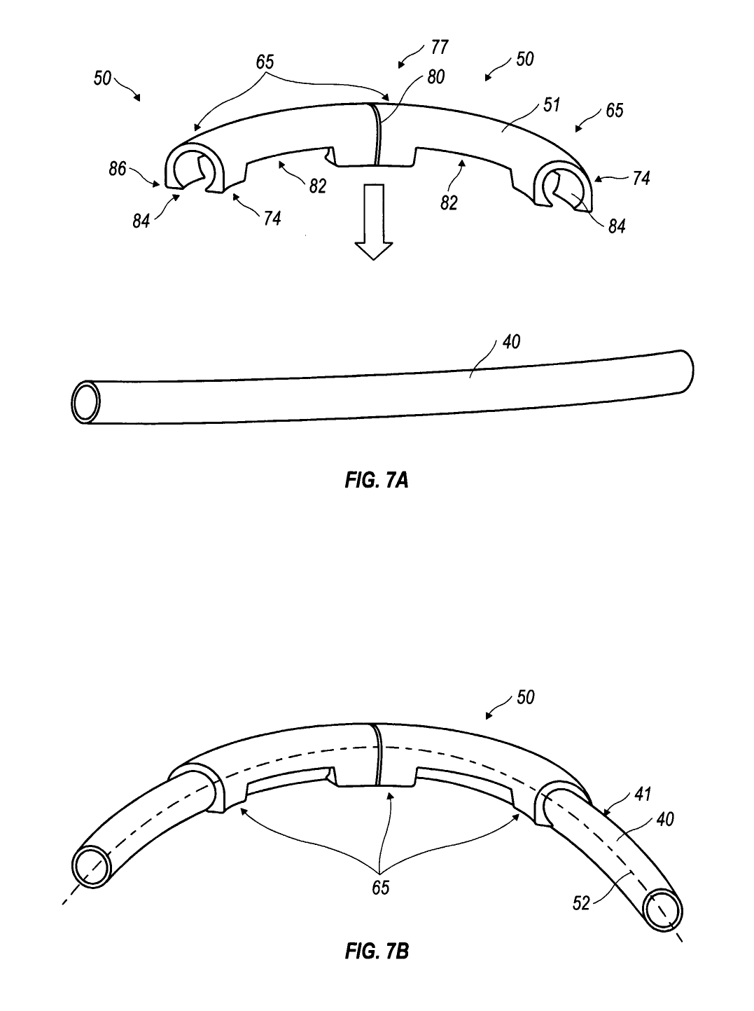

FIG. 7A illustrates, from a bottom side perspective, an exploded configuration of a shaping guide 50 positioned proximate to, and poised for installation upon, an elastically deformable tubing section 40. The shaping guide 50 comprises (includes, but is not necessarily limited to) an elongate guide body 51. The shaping guide 50 is constituted by a mid-portion 77 flanked by distal ends 74. Between the distal ends 74, securing portions 65 and extension portions 82 are alternately provided. In the illustrated embodiment of FIG. 7A, the securing portions 65 are constituted by tabs that extend off of the main portion of the elongate guide body 51. FIG. 7B discloses an assembled arrangement of a shaping guide 50 installed upon a tubing section 40. A longitudinal axis 52 is shown that constitutes both a longitudinal axis of the shaping guide 50 and the tubing section 40 because these two axes are coincident with one another. An exterior surface 41 of the tubing section 40 is also designated.

An aspect of an exemplary method of guide production is evidenced by the scored recess 80 provided at the securing portion 65 located in the mid-portion 77 of the shaping guide 50. The groove 80 is used as indicia for where the shaping guide 50 can be subdivided into shorter portions.

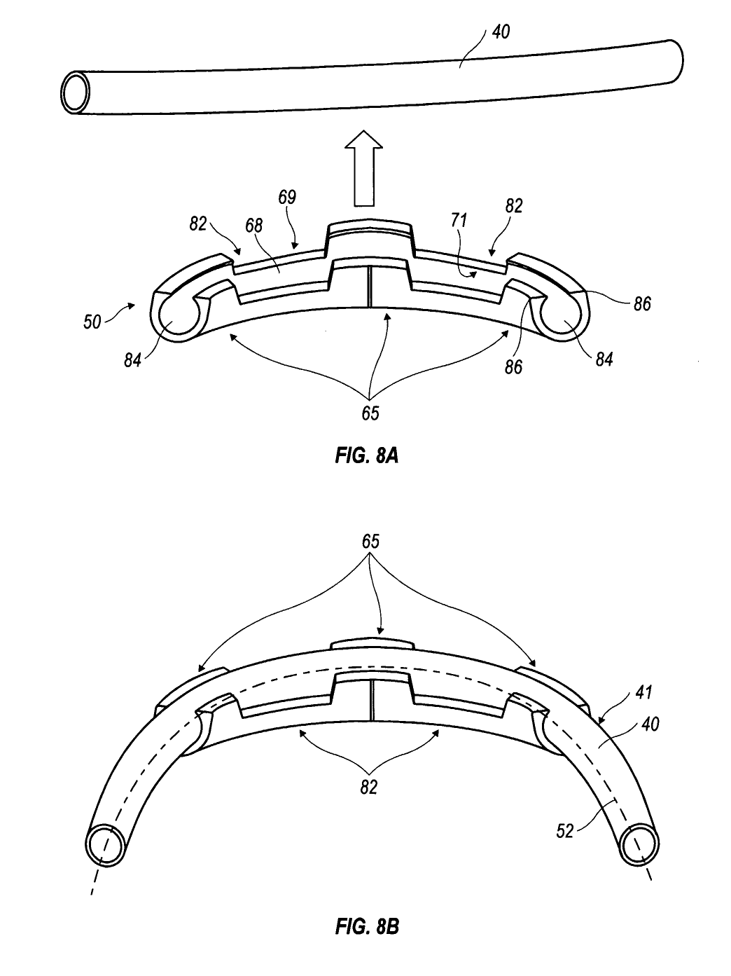

FIGS. 8A and 8B correspond to FIGS. 7A and 7B, but depict a top side perspective view. Here, an interior trap space 68, open at ends 84, is illustrated, and which is substantially defined by a tubing-facing surface 71. Advantageously, the exposed surface or wall 71 of the trap space 68 is configured for a substantial conformance fit with the exterior surface 41 of the tubing section 40. The entrance slot 69 is longitudinally continuously open into the trap space 68; and it is through this slot 69 that the tubing section 40 can be inserted into the trap space 68.

In one preferred embodiment, the invention takes the form of a shaping guide 50 for tubing 40 that is carried on a vehicle 20 and such tubing 40 has elastic deformation characteristics. The shaping guide 50 comprises an elongate guide body 51 configured to be supported exclusively on an elastically deformable tubing section 40 that is to be bent from a natural shape into a bent shape while in use upon the carrying vehicle 51. The guide body 51 defines an interior trap space 68 in which an installed tubing section 40 is retained once positioned therein.

A longitudinal axis 52 extends between two distal ends 74 of the shaping guide 50 and the longitudinal axis 52 has a lengthwise shape that substantially defines the bent shape of the installed tubing section.

As illustrated in FIGS. 7B and 8B, in the assembled configuration, the shaping guide 50 and the tubing section 40 are mated together so that longitudinal axes 52 of each are coincident with one another.

The interior trap space 68 has a tubing-facing surface 71 configured to form a substantial conformance fit with the exterior surface 41 of an installed tubing section. In this example, the tubing-facing surface 71 is substantially round in cross-sections taken perpendicular to the longitudinal axis 52. Advantageously, the tubing-facing surface 71 of the elongate guide body 51, at a first cross-section taken perpendicular to the longitudinal axis (see 82 in FIG. 7A), surrounds approximately half of the exterior surface 41 of the installed tubing section 40. The tubing-facing surface 71 of the elongate guide body 51, at a second cross-section taken perpendicular to the longitudinal axis (see 65 in FIG. 7A), surrounds a majority of the exterior surface 41 of the installed tubing section.

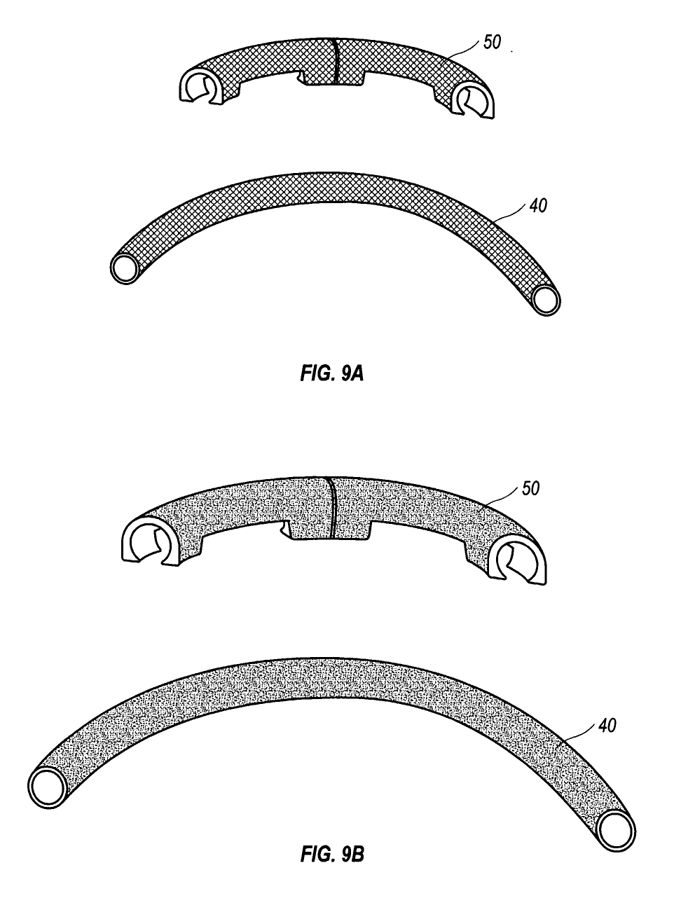

FIGS. 9A and 9B illustrate an aspect of the current invention wherein the shaping guide 50 is color-coded to match a coloring scheme used in commercially available tubing. In this manner an appropriately sized shaping guide 50 is easily selected by an installer for any particular color-coded tubing section 40. As shown, smaller sized tubing 40 of a particular color is depicted using crosshatching in FIG. 9A, and which is color-matched with the appropriately sized mating guide 50. In FIG. 9B, larger sized tubing 40 is shown in another color, denoted by stippling, together with its color-matched guide 50.

In a related aspect, it is beneficial if a particular shaping guide 50 is sized to be useable on a common tubing size of English unit measure and also on a common tubing size of metric unit measure. One example is the provision of a shaping guide 50 having an interior trap space configured/sized to establish a substantial conformance fit about both one-quarter inch round tubing and six millimeter round tubing. Another example is the provision of a shaping guide 50 having an interior trap space configured/sized to establish a substantial conformance fit about both one-half inch round tubing and twelve millimeter round tubing.

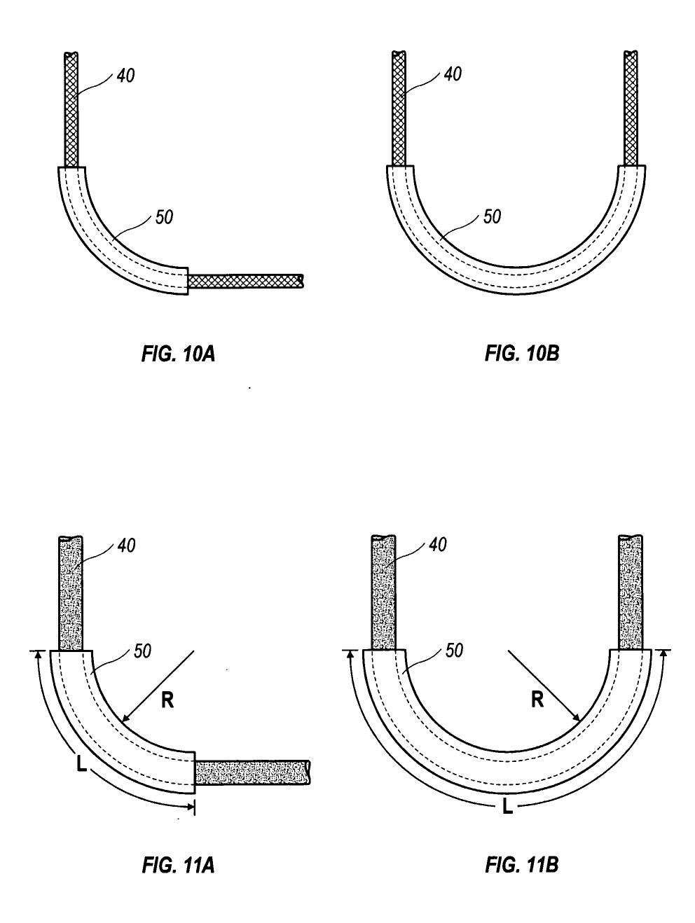

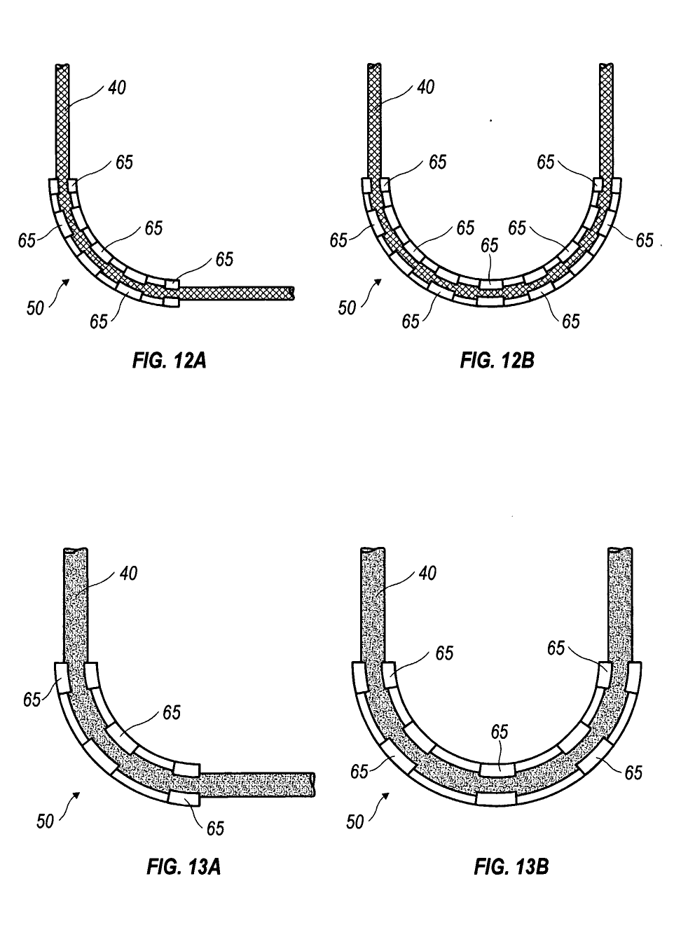

FIGS. 10A, 11A, 12A and 13A and FIGS. 10B, 11B, 12B and 13B, as groups, respectively illustrate aspects of ninety degree and one hundred and eighty degree guide/tubing combinations. FIGS. 10A through 11B show bottom plan views while FIGS. 12A through 13B show top plan views. These several figures illustrate that the size of the shaping guides 50 can be varied to accommodate differently sized tubing as indicated by the varied shading of the several tubing sections 40. Exemplary bend radii or radii of curvature (R) of the shaping guides 50 are demonstrated, as are measurable lengths (L) thereof. Still further, the variability contemplated with respect to the securing portions 65 of the guides 50 is exemplified in FIGS. 12A-13B where different numbers and spacing of the portions 65 is illustrated.

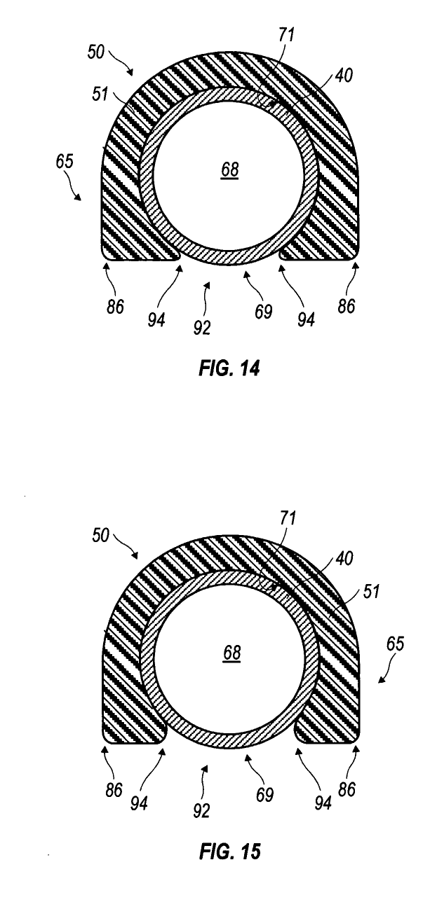

FIGS. 14 and 15 are cross-sectional views taken substantially perpendicularly to the longitudinal axis 52 of the shaping guide 50 at a securing portion 65. The guide body 51 is resiliently deformable thereby enabling pressed installation of an installed tubing section 40 through the substantially slotted entrance (entrance slot) 69 and into releasable reception in the interior trap space 68. The slotted entrance 69 is defined by a closure arrangement 92. The closure arrangement 92 comprises biased trap extension arms or projections 94 that flex outwardly from the configuration shown for admitting a tubing section 40 when press-installed into the trap space 68. After expanding to allow admittance of the tubing 40, the extension arms 94 snap back to their original configuration thereby releasably securing the tubing section 40 in the interior trap space 68 of the shaping guide 50. Tip ends of the extension arms 94 are alternatively illustrated between FIGS. 14 and 15, but each terminates in a bull-nose configuration that is blunted to avoid damaging tubing that is press-installed therebetween. For similar protective reasons, exterior corners 86 of the shaping guide 50 are also rounded to remove potentially harmful sharp edges.

As previously indicated, the described and illustrated exemplary embodiments are intended to assist persons skilled in the art to understand the presently disclosed invention, and are not to be considered as limitations upon the afforded patent protection which is exclusively recited in the following patented claims.

1. A shaping guide for elastically deformable tubing carried on a vehicle, said guide comprising:
an elongate guide body defining an interior trap space to receive and retain an installed tubing section to be bent from a natural shape to a preferred shape while in use upon a carrying vehicle, wherein said interior trap space has a longitudinally continuously open slotted entrance to receive a portion of tubing inserted in a lateral direction, and wherein said elongate guide body is configured to be supported solely on the elastically deformable tubing section.

2. The shaping guide as recited in claim 1, wherein said shaping guide has a longitudinal axis extending between two distal ends of said shaping guide and wherein said shaping guide has a permanently formed shape along said longitudinal axis substantially defining a desired bent shape of an installed tubing section.

3. The shaping guide as recited in claim 2, wherein said longitudinal axis of said shaping guide is positioned relative to said guide body to be substantially coincident with a longitudinal axis of an installed tubing section.

4. The shaping guide as recited in claim 2, wherein said interior trap space has a tubing-facing surface configured to form a substantial conformance fit with an exterior surface of an installed tubing section.

5. The shaping guide as recited in claim 4, wherein said tubing-facing surface is substantially round in cross-sections taken perpendicular to said longitudinal axis.

6. The shaping guide as recited in claim 2, wherein a tubing-facing surface of said elongate guide body has a longitudinally continuous first portion which, at a first cross-section taken perpendicular to said longitudinal axis, surrounds approximately half of an exterior surface of an installed tubing section at said first cross-section.

7. The shaping guide as recited in claim 6, wherein the tubing-facing surface of said elongate guide body has at least one second portion which, at a second cross-section taken perpendicular to said longitudinal axis, surrounds a majority of an exterior surface of an installed tubing section at said second cross-section, said at least one second portion defining the slotted entrance.

8. The shaping guide as recited in claim 2, wherein the guide body includes a tubing-facing surface including a plurality of tabs each tab, at a cross-section taken perpendicular to said longitudinal axis, surrounds a majority of an exterior surface of an installed tubing section at said first cross-section, said plurality of tabs defining the slotted entrance.

9. The shaping guide as recited in claim 2, wherein said longitudinal axis of said shaping guide has a curved shape defined by a radius.

10. The shaping guide as recited in claim 2, wherein said shaping guide constitutes a means for bending an installed tubing section on a radius lesser than a prescribed minimum bend radius of said tubing section when said longitudinal axis is configured on a radius shorter than the prescribed minimum bend radius of the tubing section.

11. The shaping guide as recited in claim 10, wherein said shaping guide provides substantially continuous support to an installed tubing section thereby enabling a reduction to the tubing section's minimum bend radius by as much as ten percent.

12. The shaping guide as recited in claim 1, wherein said interior trap space is configured to establish a substantial conformance fit about a common English-unit tubing size and a common metric-unit tubing size.

13. The shaping guide as recited in claim 1, wherein said interior trap space is configured to establish a substantial conformance fit about both one-quarter inch round tubing and six millimeter round tubing.

14. The shaping guide as recited in claim 1, wherein said interior trap space is configured to establish a substantial conformance fit about both one-half inch round tubing and twelve millimeter round tubing.

15. (canceled)

16. The shaping guide as recited in claim 1, wherein said guide body has resiliently deformable retaining tabs defining the slotted entrance thereby enabling pressed installation of an installed tubing section through said substantially slotted entrance and into releasable reception in said interior trap space.

17. The shaping guide as recited in claim 1, wherein said shaping guide is constructed from sufficiently lightweight material that assures that substantially no deformation is induced in tubing upon which said shaping guide is installed due to said shaping guide's weight.

18. A shape maintaining guide for tubing carried on a vehicle during heat processing at temperatures sufficiently high to permit plastic deformation of the tubing's shape under the tubing's own weight, said guide comprising:
an elongate guide body configured to be at least partially supported on an elastically deformable tubing section that is to be maintained in a prescribed configuration when exposed to temperatures sufficiently high to permit plastic deformation of the tubing's shape under the tubing's own weight; and
said guide body defining an interior trap space substantially continuously open along a longitudinal direction of the guide body providing a substantially slotted entrance into said interior trap space in which an installed tubing section is retained once positioned therein.

19. The shape maintaining guide as recited in claim 18,
wherein said guide body has a permanent shape along a longitudinal axis extending between two distal ends of said shape maintaining guide substantially defining a prescribed configuration of an installed tubing section.

20. The shape maintaining guide as recited in claim 19, wherein said longitudinal axis of said shape maintaining guide is oriented to be substantially coincident with a longitudinal axis of an installed tubing section.

21. The shape maintaining guide as recited in claim 19, wherein said interior trap space has a tubing-facing surface configured to form a substantial conformance fit with an exterior surface of an installed tubing section.

22. The shape maintaining guide as recited in claim 21, wherein said tubing-facing surface is substantially round in cross-sections taken perpendicular to said longitudinal axis.

23. The shape maintaining guide as recited in claim 19, wherein a tubing-facing surface of said elongate guide body has a longitudinally continuous first portion which, at a first cross-section taken along an extension portion of said guide body and perpendicular to said longitudinal axis, surrounds approximately half of an exterior surface of an installed tubing section at said first cross-section.

24. The shape maintaining guide as recited in claim 23, wherein a tubing-facing surface of said elongate guide body has a second portion which, at a second cross-section taken along a securing portion of said guide body and perpendicular to said longitudinal axis, surrounds a majority of an exterior surface of an installed tubing section at said second cross-section.

25. The shape maintaining guide as recited in claim 19, wherein a tubing-facing surface of said elongate guide body has a plurality of arms, each arm, at a cross-section taken along a securing portion of said guide body and perpendicular to said longitudinal axis, surrounds a majority of an exterior surface of an installed tubing section at said cross-section.

26. The shape maintaining guide as recited in claim 18, wherein said interior trap space is configured to establish a substantial conformance fit about a common English-unit tubing size and a common metric-unit tubing size.

27. The shape maintaining guide as recited in claim 18, wherein said interior trap space is configured to establish a substantial conformance fit about both one-quarter inch round tubing and six millimeter round tubing.

28. The shape maintaining guide as recited in claim 18, wherein said interior trap space is configured to establish a substantial conformance fit about both one-half inch round tubing and twelve millimeter round tubing.

29. (canceled)

30. The shape maintaining guide as recited in claim 18, wherein said guide body includes resiliently deformable tabs at the slotted entrance for pressed installation of an installed tubing section through said substantially slotted entrance and into releasable reception in said interior trap space.

31. The shape maintaining guide as recited in claim 18, wherein said shape maintaining guide is constructed from sufficiently lightweight material that assures that substantially no deformation is induced in tubing upon which said shape maintaining guide is installed due to said shape maintaining guide's weight.
